(19) United States
(12) Patent Application Publication
(10) Pub. No.: US 2023/0060970 A1
(43) Pub. Date: Mar. 2, 2023

(54) Collapsible Vehicle Baby Change Table

(71) Applicant: Candido Martinez, Walthan, MA (US)

(72) Inventor: Candido Martinez, Walthan, MA (US)

(21) Appl. No.: 17/412,538

(22) Filed: Aug. 26, 2021

(51) Int. Cl. B60N 3/00; A47D 5/00

(52) U.S. Cl. CPC B60N 3/001; A47D 5/006

(57) ABSTRACT

The disclosure Chinos Idea is the only product of its kind that allows users to easily connect a retractable changing table in their vehicle to facilitate the car diaper changing process. This innovative, top quality product is uniquely designed to be easily portable and foldable to ensure users are able to access this product quickly, when necessary. Moreover, Chinos Ideas is strategically crafted with heavy duty materials to ensure long term sustainability and can be used in all vehicle makes and models, as a post-option or build-in accessory. Furthermore, the portable table disclosed includes a transition seam L on a mid portion of the back plate and configured to support a raising and a lowering via a hook and loop secured overlap of a lower part of the back plate against a top part of the back plate in accordance with an embodiment of the present disclosure.

### BACKGROUND

One of the biggest concerns for parents or caregivers when it comes to road travel with an infant is how to change a diaper without the perfect setup of a changing table that would otherwise be available in other environments. In fact, changing a baby's diaper in a car has been considered one of the most difficult places for parents to conduct that care/service for their infant. The tight spacing and lack of sturdiness in cars can make this process incredibly tedious, messy and time consuming for the parents and uncomfortable for the child. There have been no products available as original equipment or as an aftermarket to address this problem.

An apparatus to simplify the process of changing a baby's diaper while in a vehicle. There have been no products available as original equipment or as an aftermarket to address this problem either.

There exists a need for an apparatus such as the collapsible vehicle baby change table that is not being met by any known or disclosed device or system of present.

### SUMMARY OF THE INVENTION

The main purpose of a collapsible vehicle baby change table is to provide users with a portable car diaper changing station.

### BRIEF DESCRIPTION OF THE DRAWINGS

FIG. 1 is a front perspective view of a collapsible vehicle baby change table in accordance with an embodiment of the present disclosure.

FIG. 2 is a back perspective view of a collapsible vehicle baby change table in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

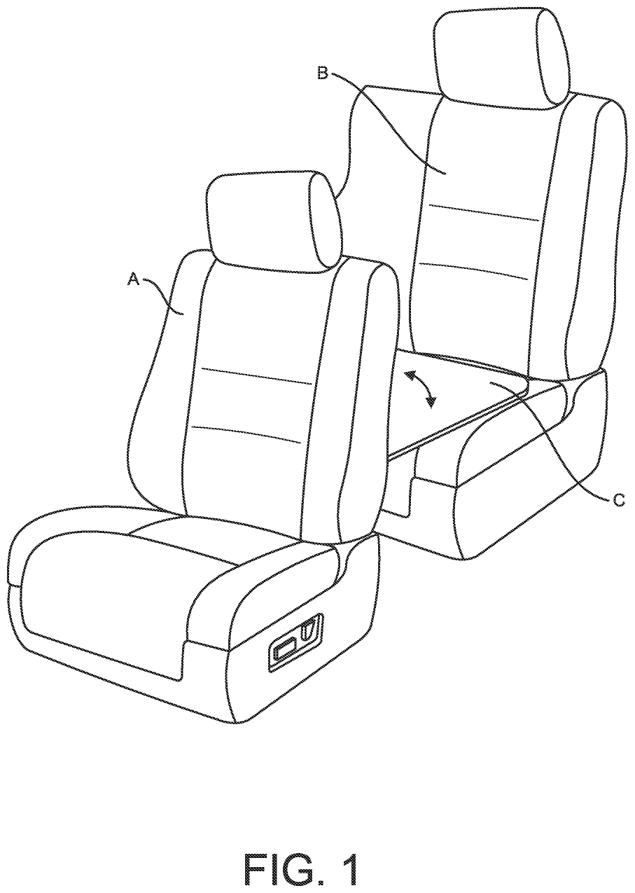

FIG. 1 is a front perspective view of a collapsible vehicle baby change table showing: Driver seat or front passenger seat referenced as A., Rear passenger seat referenced as B., Sturdy folding changing table referenced as C., in accordance with an embodiment of the present disclosure.

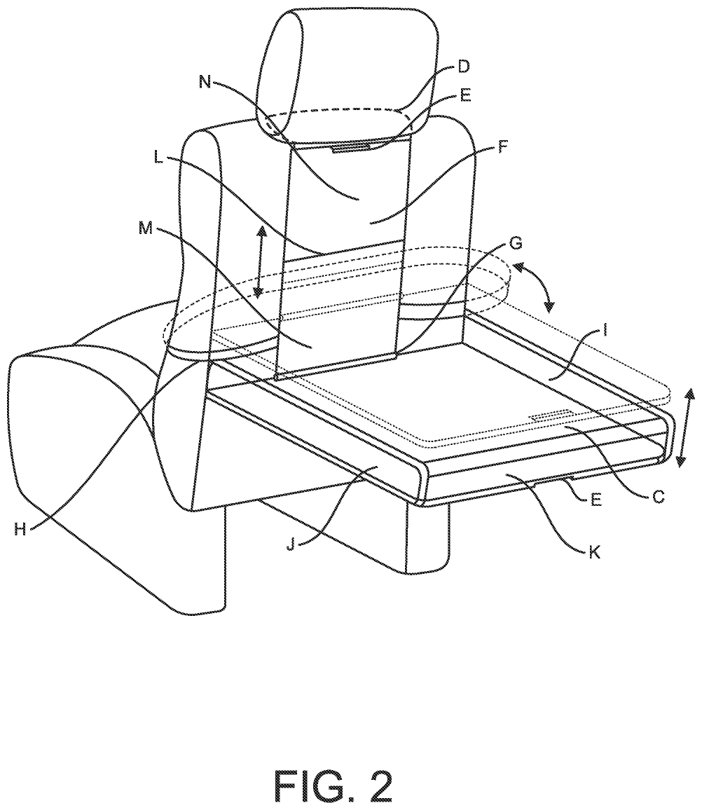

FIG. 2 is a back perspective view of a collapsible vehicle baby change table showing: Sturdy folding changing table top referenced as C., Chain goes around front head rest referenced as D., Latch to hold changing table in upward position referenced as E., Back plate referenced as F., Molded hinge referenced as G., in accordance with an embodiment of the present disclosure. The present view also includes a seat strap H which secures the table top C onto the seat and seat back B. The present view also includes a right bumper I foldable from a right edge of the table top and a left bumper J foldable from a left edge of the table top C. The present view also includes the front bumper K which foldingly or hingedly attaches to the front side of the table top C opposite the hinge G. The transition seam L provides for a raising and a lowering of the table top C against the back of seat C by folding the back plate F or by overlapping a bottom part of the back plate M against a top part of the back plate F in accordance with an embodiment of the present disclosure.

Furthermore, the portable table disclosed includes a transition seam L on a mid portion of the back plate and configured to support a raising and a lowering via a hook and loop secured overlap of a lower part of the back plate against a top part of the back plate in accordance with an embodiment of the present disclosure.

The present disclosed collapsible vehicle baby change table, also known as “Chinos Idea” enables parents to easily install and embed a changing table within their vehicles to allow for a convenient and simple car diaper changing operation. Expanding on the initial design of the front driver/passenger seats in an automobile, Chinos Idea introduces a novel sturdy folding changing table that can be securely wrapped around the front headrest of the seat via a chain. A durable latch attaches to the back plate to hold the changing table in an upward motion to ensure a stable platform at all times. In return, users are able to conveniently change their baby's diapers in the comfort of their own vehicles with ease as the accessory allows for a smoother, clearly defined area that can ensure a more pleasant experience for both the infant and the parent. This unprecedented product offers a compact yet fully operational vehicle baby changing table to enhance the functionality of an automobile.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A portable table comprising:
a table top comprising a rigid construction;
a back plate comprising a rigid construction;
a hinge configured to connect an edge of the table top with an edge of the back plate; and
a latch configured to hold the table top to the back plate.

2. The portable table of claim 1, wherein the hinge is configured to limit a folding movement of the table top to a ninety degree angle in relation to the back plate.

3. The portable table of claim 1, further comprising a chain configured to secure the back plate to a head rest of a car seat.

4. The portable table of claim 1, further comprising a tether configured to secure the back plate to a head rest of a car seat.

5. The portable table of claim 1, further comprising a strap configured to secure the back plate to a seat back in a car.

6. The portable table of claim 1, wherein the table top is configured to extend from the back plate onto a top cushion of a car seat behind the back plate.

7. The portable table of claim 1, wherein the latch is configured at an edge of the table top and an edge of the back plate opposite the hinge.

8. The portable table of claim 1, wherein the hinge is a molded hinge having a part molded into the table top edge and a part molded into the back plate edge.

9. The portable table of claim 1, further comprising a left bumper and a right bumper foldingly attached to a left side and a right side of the table top.

10. The portable table of claim 1, further comprising a front bumper foldingly attached to a front side of the table top opposite the hinge.

11. The portable table of claim 1, further comprising a left bumper and a right bumper hingedly attached to a left side and a right side of the table top.

12. The portable table of claim 1, further comprising a front bumper hingedly attached to a front side of the table top opposite the hinge.

13. The portable table of claim 1, further comprising an adjustable seam in the back plate configured to support a raising and a lowering of the back plate against a back of a car seat.

14. The portable table of claim 1, further comprising a hook and a loop seam on a mid portion of the back plate and configured to support a raising and a lowering of the back plate against a back of a car seat.

15. The portable table of claim 1, further comprising a transition seam on a mid portion of the back plate and configured to support a raising and a lowering via a secured overlap of a lower part of the back plate against a top part of the back plate.

16. The portable table of claim 1, further comprising a transition seam on a mid portion of the back plate and configured to support a raising and a lowering via a hook and loop secured overlap of a lower part of the back plate against a top part of the back plate.
